(19) United States
(12) Patent Application Publication
(10) Pub. No.: US 2013/0108816 A1
(43) Pub. Date: May 2, 2013

(54) MULTI-LAYER FLUOROPOLYMER FOAM STRUCTURE

(71) Applicant: Saeid Zerafati, Villanova, PA (US)

(72) Inventor: Saeid Zerafati, Villanova, PA (US)

(73) Assignee: Arkema Inc., King of Prussia, PA (US)

(21) Appl. No.: 13/594,056

(22) Filed: Aug. 24, 2012

Related U.S. Application Data
(63) Continuation-in-part of application No. 13/266,673, filed on Oct. 27, 2011.

(51) Int. Cl. B32B 27/06; B32B 5/32; B32B 1/08; B32B 5/20; B29C 44/06; B32B 27/30

(52) U.S. Cl. 428/36.5; 264/54; 428/319.7; 428/318.6; 428/212; 428/375; 428/339; 428/218

(57) ABSTRACT

The invention relates to multi-layer articles consisting of at least one layer of a foamed fluoropolymer. The article is formed by co-extrusion in which the foamed layer is coextruded as a foam, and not foamed in a secondary process. Preferably the fluoropolymer foam is a polyvinylidene fluoride (PVDF), such as KYNAR PVDF from Arkema Inc. The article could be sized into a specific shape during the manufacturing process. Useful multi-layer articles of the invention include pipe, tube, sheet, profile, film, jacketing or any other multilayer foam-core articles are especially useful.

This application is a continuation in part of U.S. patent application Ser. 13/266,673, filed Oct. 27, 2011, from which priority is claimed. This application also claims benefit, under U.S.C. §119(e) of U.S. Provisional Application No. 61/174,745, filed May 1, 2009, and PCT/US10/32038 filed Apr. 22, 2010. These applications are incorporated herein by reference.

### FIELD OF THE INVENTION

The invention relates to multi-layer articles consisting of at least one layer of a foamed fluoropolymer. The article is formed by co-extrusion in which the foamed layer is coextruded as a foam, and not foamed in a secondary process. Preferably the fluoropolymer foam is a polyvinylidene fluoride (PVDF), such as KYNAR PVDF from Arkema Inc. The article could be sized into a specific shape during the manufacturing process. Useful multi-layer articles of the invention include pipe, tube, sheet, profile, film, jacketing or any other multilayer foam-core articles are especially useful.

### BACKGROUND OF THE INVENTION

Fluoropolymers, and polyvinylidene fluoride in particular, possess many favorable physical properties that make them the material of choice in many applications. Polyvinylidene fluoride (PVDF) and its copolymers, especially with hexafluoropropene (HFP), have some unique properties including excellent weathering, chemical resistance, permeation resistance and flammability, which make them an excellent choice for many applications. PVDF is widely used in both coating and melt-processable applications. Unfortunately PVDF has a relatively high density, and can be more costly than other more commodity polymer resins.

There is a desire to reduce the density and reduce the cost of PVDF, with little or no decrease in the excellent physical and chemical properties provided.

One method to reduce the density of PVDF and other crystalline or semi-crystalline fluoropolymers is through formation of a foam. Unfortunately, poor melt strength and difficulty in controlling the cell formation in the molten state has generally limited the foaming of crystalline or semi-crystalline polymers to either a batch process, foaming with support, or some exotic process such as latex freezing (U.S. Pat. No. 7,081,216). In the batch process, solid polymer is formed first, typically into a film through extrusion, cross linked through radiation, soaked in a gas under pressure for extended amount of time and then foamed at higher temperature typically into a slab. It is impossible to make hollow or long articles, such as pipes, with solid skins using this method. In the supported foam technique (U.S. Pat. No. 4,781,433), in order to overcome the poor melt strength, foamed polymer is extruded on or around a carrier or wire to prevent it from collapsing. The foam extruded in this case would not be able to hold its own shape without the support of a carrier, especially in large size applications. Therefore, it is not possible to size the product or create a hollow freestanding structure. As the result, this technology is limited to making PVDF wire coating.

Multi-layered polymeric structures are useful to take advantage of the properties of the different polymers. The multi-layer structures (or sheets) are found in parts used in many industries, including the automotive industry; communications, medical devices, and building and construction, etc. When preparing multilayer structures, the layers of the structures must adhere securely to each other.

In the pipe extrusion industry there is a trend away from single layer pipe to pipes with additional functional layers. Foam core pipes are already in use for PVC, ABS and PP. For foam core pipes, weight and cost advantage over single layer compact pipe with the same dimension are reported as major advantages. Dimensional stability, higher stiffness, better impact properties, ease of cut, better heat, cold and sound insulations are also other advantages of these pipes.

The foam-core structure consists of a solid layer attached to a foamed layer, which may be of the same or different composition. In some cases, the foamed layer is sandwiched between two solid layers. Foam-core structures are typically made by a co-extrusion process, where the foam is co-extruded with one or more solid layers. In coextrusion, the adjoining layers are initially in a melt phase, allowing for the polymer chains on the surface of each layer to intertwine—creating chain entanglements that improves adhesion of the layers.

There is a need for a multi-layer foam-core structure having a semi-crystalline or crystalline fluoropolymer foam.

Surprisingly it has been found that multi-layer/multi-material semi-crystalline and crystalline fluoropolymer-containing foamed articles can be manufactured by a coextrusion process. The technology is capable of producing multilayer articles with at least one layer of foamed material. The direct coextrusion of a foam produces good adhesion between the fluoropolymer foam layer(s) and the solid layer(s).

### SUMMARY OF THE INVENTION

The invention relates to a multi-layer structure comprising at least two layers that are coextruded with each other, wherein at least one layer comprises a foamed crystalline or semi-crystalline fluoropolymer having a density of at least 3 percent less than an unfoamed semi-crystalline fluoropolymer of the same composition, and wherein said foamed semi-crystalline fluoropolymer is coextruded as a foam.

The invention also relates to a process for producing the multi-layer structure and the use of the structure, especially as a foam-core pipe or tube.

### BRIEF DESCRIPTION OF THE FIGURES

FIG. 1 shows a setup for a five layer die and the extruders connected to it.

FIG. 2 is magnified cross section of a foam-core sample, showing the two dense layers on the outside and inside and the foamed internal layer.

### DETAILED DESCRIPTION OF THE INVENTION

The invention relates to a co-extruded multi-layer fluoropolymer foam structure. The foamed layer has interfacial contact with at least one other layer of the same or different material.

All percentages used herein are weight percentages, unless otherwise specified, and all molecular weights are weight average molecular weights, unless otherwise specified.

### Multilayer Structure

The multilayer structures of the invention include films, sheets, profiles and other articles having two or more structural layers, with at least one layer being a crystalline or semicrystalline fluoropolymer foam. The structures may be planar, curved, angled or of any shape including pipes, tubes and hollow structures. By structural layers is meant a layer included in the structure to provide specific properties to the structure. Specifically, the term structural layer is meant to exclude adhesive or tie layers, though these may be present in the structure in addition to the two or more structural layers.

As used herein, the term “layer” refers to each strata composed of one or more different materials, which can be of the same or different compositions, and which are secured to one another. It is preferred that the co-extruded materials are adhered to each other by the inherent tendency of the materials to adhere by chain entanglement or chemical bonding during the co-extrusion process, though adhesion can also be induced by added heating, radiation, chemical, or any appropriate process. The multi-layer structure of the invention has a total thickness of from 10 to 100,000 microns, preferably from 100 to 20,000 microns. Each solid layer has a thickness of from 10-25,000 microns, preferably 25-5000 microns, more prefer 50-500 microns, and each foam layer has a thickness of from 25-50,000 microns, preferably from 50-10,000 microns, more preferably from 250-5000 microns. A “different” layer means any change in the composition or density of one layer compared to another layer. Two identical layers could exist in the multilayer structure, as in the case of a three layer structure having an inner core layer and covered on both sides with two identical material layers. In one embodiment, a fluoropolymer foam could be co-extruded with a solid fluoropolymer of the same composition.

While the number of layers in the structures of the invention are not limited—except by the equipment capacity, preferably the number of layers is 7 or less, more preferably 5 or less, and most preferably 2 or 3. The layers of fluoropolymer foam can be on the inside or outside of the structure. Structures having more than one foam layer are also contemplated, including one layer of fluoropolymer foam with one layer of non fluoropolymer foam, or two layers of fluoropolymer foam that may have the same or different compositions and the same or different densities. Multiple foam layers could be adjacent to each other, or could be separated by a solid layer.

### Fluoropolymer Foam

Fluoropolymers useful as a foamed polymer of the invention include crystalline and semi-crystalline fluoropolymers. These polymers are thermoplastic, as they must melt and flow in the co-extrusion process. By “semi-crystalline”, as used herein is meant that the polymer has at least 5% by weight crystalline, and preferably at least 10% crystalline content, as measured DSC. The DSC measurement is run on a 10 mg sample from RT to 210° C. at 20 C./min held for 5 min, cooled from 210° C. to −20° C. at 20° C. per minute, then heated from −20° C. to 210° C. at 10° C. per min. The heat of melting is calculated by standard methods and the percent crystallinity is calculated by dividing the J/g heat of melting by 105 J/g for 100% crystalline PVDF and multiplying by 100. For example, a measurement of 50 J/g heat of melting would mean 47.6% crystallinity.

The fluoropolymers of the invention include, but are not limited to polymers containing at least 50 weight percent of one or more fluoromonomers. The term “fluoromonomer” as used according to the invention means a fluorinated and olefinically unsaturated monomer capable of undergoing free radical polymerization reaction. Useful thermoplastic fluoropolymers of the invention include, but are not limited to: chlorotrifluoroethylene (CTFE), ethylene-tetrafluoroethylene (ETFE), perfluorinated ethylene-propylene copolymer (EFEP), ethylene-chlorotrifluoroethylene (ECTFE). VF₂, copolymers of tetrafluoroethylene and hexafluoropropene, THV. Vinyl fluoride copolymers that are thermoplastic in nature may also be used.

Preferably the fluoropolymer is a polyvinylidene fluoride (PVDF). The invention will be exemplified in terms of PVDF, but one of ordinary skill in the art will recognize that other semi-crystalline or crystalline thermoplastic fluoropolymers could be represented where the term PVDF is exemplified.

The polyvinylidene fluoride (PVDF) of the invention is a PVDF homopolymer, copolymer or polymer alloy. Polyvinylidene fluoride polymers of the invention include the homopolymer made by polymerizing vinylidene fluoride (VDF), and copolymers, terpolymers and higher polymers of vinylidene fluoride, where the vinylidene fluoride units comprise greater than 51 percent by weight, preferably 70 percent of the total weight of all the monomer units in the polymer, and more preferably, comprise greater than 75 percent of the total weight of the monomer units. Copolymers, terpolymers and higher polymers (generally referred to herein as “copolymers”) of vinylidene fluoride may be made by reacting vinylidene fluoride with one or more monomers from the group consisting of vinyl fluoride, trifluoroethene, tetrafluoroethene, one or more of partly or fully fluorinated alpha-olefins such as 3,3,3-trifluoro-1-propene, 1,2,3,3,3-pentafluoropropene, 3,3,3,4,4-pentafluoro-1-butene, and hexafluoropropene, the partly fluorinated olefin hexafluoroisobutylene, perfluorinated vinyl ethers, such as perfluoromethyl vinyl ether, perfluoroethyl vinyl ether, perfluoro-n-propyl vinyl ether, and perfluoro-2-propoxypropyl vinyl ether, fluorinated dioxoles, such as perfluoro(1,3-dioxole) and perfluoro(2,2-dimethyl-1,3-dioxole), allylic, partly fluorinated allylic, or fluorinated allylic monomers, such as 2-hydroxyethyl allyl ether or 3-allyloxypropanediol, and ethene or propene. Preferred copolymers or terpolymers are formed with vinylidene fluoride and one or more of vinyl fluoride, trifluoroethene, tetrafluoroethene (TFE), hexafluoropropene (HFP), and chlorofluoroethylene.

Preferred copolymers include those comprising from about 60 to about 99 weight percent VDF, and correspondingly from about 1 to about 40 percent HFP; copolymers of VDF and CTFE; terpolymers of VDF/HFP/TFE; and copolymers of VDF and EFEP

The PVDF of the invention could also be an alloy of PVDF and a miscible, semi-miscible, or compatible polymer. Since most alloys of PVDF result in some diminishment of the PVDF properties, a preferred PVDF is one that is not an alloy. However, small amounts of other polymers, up to 30 percent of the total PVDF polymer alloy may be added. Other fluoropolymers, thermoplastic poly urethane (TPU) and (meth)acrylic polymers are examples of useful polymers that may make up a useful polymer alloy.

In one embodiment, the fluoropolymer is a branched fluoropolymer. A branched fluoropolymer could result in larger cells, and could be a useful choice in foil ling a foamed multi-layer film.

In another embodiment, the fluoropolymer foam is formed from a functional fluoropolymer, including as a non-limiting example a maleic anhydride-grafted PVDF (such as KYNAR ADX from Arkema Inc.). Use of a functionalized PVDF foam could further increase adhesion to other layers of a multi-layer structure.

### Foaming Process

The foamed layer(s) can be manufactured through any foaming process including but not limited to the use of physical or chemical blowing agents and nucleating agents. As opposed to other structures in the art in which a solid fluoropolymer layer is formed in one step, and is latter foamed in a second process, the fluoropolymer foam layer of the present invention is co-extruded directly as a foam.

In the case of the chemical blowing agent, the gas is created by decomposition of a chemical by heating it above its degradation temperature. In the case of the physical blowing agent, gas is introduced into the polymer either directly or through evaporating a liquid foaming agent by heating it above its evaporation temperature. Chemical blowing agents are mainly used for higher density foams—down to 70% density reduction, while physical blowing agents can produce light foams—upwards of 10× density reduction.

Blowing agents useful in the invention can be either chemical or physical blowing agents, or a mixture thereof. In the case of a chemical blowing agent, the gas is created by decomposition of a chemical heated above its degradation temperature. In the case of the physical blowing agent, gas is introduced into the polymer either directly or through evaporating a liquid foaming agent by heating it above its evaporation temperature. Chemical blowing agents are mainly used for higher density foams—down to 70% density reduction, while physical blowing agents can produce light foams—upwards of 10× density reduction. A combination of chemical and physical blowing agents can also be used.

The chemical blowing agent can be a solid or fluid. Useful blowing agents include, but are not limited to, azodicarbonamide, azodiisobutyronitile, sulfonylsemicarbazide, 4,4-oxybenzene, barium azodicarboxylate, 5-Phenyltetrazole, p-toluenesulfonylsemicarbazide, diisopropvl hydrazodicarboxylate, 4,4′-oxybis(benzenesulfonylhydrazide), diphenylsulfone-3,3′-disulfohydrazide, isatoic anhydride, N,N′-dimethyl-N,N′dinitroterephthalamide, citric acid, sodium bicarbonate, monosodium citrate, anhydrous citric acid, trihydrazinotriazine, N,N′-dinitrosopentamethylenetetramine, and p-toluenesulfonylhydrazide, or include a blend two or more of said blowing agents. Mixtures of chemical and physical blowing agents are also contemplated by the invention.

The foam of the invention may optionally be formed using a nucleating agent that aids in producing a homogeneous foam. In one preferred embodiment, no added nucleating agent is added. In some cases, a chemical foaming agent could act as both a foaming agent and a nucleating agent. A nucleating agents may be useful when a chemical blowing agent is used and is necessary for forming a controlled foam with physical blowing agents. A mixture of two or more nucleating agents can be used. Useful nucleating agents include, but are not limited to calcium carbonate, calcium sulfate, magnesium hydroxide, magnesium silicate hydroxide, calcium tungstate, magnesium oxide, lead oxide, barium oxide, titanium dioxide, zinc oxide, antimony oxide, boron nitride, magnesium carbonate, lead carbonate, zinc carbonate, barium carbonate, calcium silicate, aluminosilicate, carbon black, graphite, non organic pigments, alumina, molybdenum disulfide, zinc stearate, PTFE particles, immiscible polymer particles, and calcium metasilicate. A preferred nucleating agent is calcium carbonate. Nucleating agents that have smaller particle size, and have rougher surfaces are preferred.

In one preferred embodiment, the fluoropolymer foamed structure is produced using one or more master batch concentrate(s) containing an optional nucleating agent, at least one chemical blowing agent in the case where a chemical blowing agent is used, and optional other additives, in a suitable carrier. The purpose of the master batch is to provide a more precise addition of ingredients used at low level, and to do so in a manner providing excellent homogeneous mixing of components within the PVDF, leading to homogeneous foam formation. Moreover, the additives are usually in the form of fine powders that need to be added to the polymer pellets and would phase separate in the extruder hopper.

The master batch contains a high concentration of the required additives in the final product (sometimes 10 to 50 times more concentrated). In one embodiment the master batch contains 1 to 20 weight percent of a blowing agent, and, if present from 0.5 to 20 weight percent of nucleating agent. The master batch is then generally mixed with the PVDF pellets in a dry blend form and introduced in the extruder hopper. This process is called letting down the concentrate. In the let down process, depending on the concentration of the additives in the master batch and also the required amount of the additives in the final product, anything between several percent to sometimes over 50% of the master batch concentrate is added to the polymer resin.

It is possible to have multiple master batches, each containing one or more of the additives to be mixed into the PVDF. One advantage of multiple master batches would be that a manufacturer could adjust the ratio of the additives at the point of manufacture. An example of multiple master batches would be a first master batch containing a nucleating agent, and a second master batch containing a blowing agent.

The foam has good mechanical stability and load bearing properties for PVDF foamed structures having density reductions down to 50% of the original density, making them useful as pipes that could hold pressure, or rods or profiles that could carry loads. The foamed structure has a density that is at least 3% less than said non-foamed PVDF, and more preferably at least 25% less. The density reduction could be 35% less, 50% less and even as high as 100 times less dense than the non-foamed PVDF material. The structures are typically joined together or attached to standard couplings or fittings and can be manufactured with a tight tolerance. For example, 4″ schedule 40 pipes have an outside diameter of 4.500″ with a tolerance of +/−0.009″ and a thickness of 0.251″ with a tolerance of +/−0.016″. The foamed PVDF of this invention would have the melt strength to go through sizing and calibration enabling one to form and size the PVDF foam structure to such a close tolerances.

Preferably, the foam cell size is as small as possible. The cell size could be as small as 1 micron. Generally the cell size is in the range of from 10 to 250 microns, more typically in the range of from 50 to 150 microns.

### Other Layers

In addition to at least one layer of foamed crystalline or semi-crystalline fluoropolymer, the foamed multi-layer structure of the invention contains at least one other layer that is co-extruded with the foam.

In one embodiment, two layers of foam may be coextruded together, in which the foam densities of the foams are different, or the compositions are different, or both.

In one preferred embodiment, a fluoropolymer foam is coextruded with a solid fluoropolymer of a similar or the same composition. In another embodiment, the fluoropolymer foam is coextruded with a thermoplastic non-fluoropolymer. Examples of useful non-fluoropolymers that are compatible with the fluoropolymer foam include, but are not limited to (meth)acrylates and thermoplastic polyurethane (TPU).

In a preferred embodiment, a layer of the fluoropolymer foam is coextruded between two layers of solid fluoropolymer, to form a foam-core structure.

Depending on the composition of the non-fluoropolymer layer, a thin tie layer or adhesive can be coextruded between the foam and the solid structural layer.

It is preferred that the melting points of the layers, and the viscosities of each layer be relatively similar, to facilitate coextrusion. Preferably the difference in melting points of adjoining layers is less than 60° C., and more preferably less than 25° C.

### Additives:

One or more additives may optionally be added to the fluoropolymer foam layer composition, or the composition of the other layers. Typical additives include, but not limited to, impact modifiers, UV stabilizers, plasticizers, fillers, coloring agents, pigments, dyes, antioxidants, antistatic agents, surfactants, toner, pigments, flame retardant, and dispersing aids.

### Process:

Generally, a continuous co-extrusion process is used for manufacturing the multilayer foam structure of the invention. In this process, several extruders are used to feed multiple materials into a die that would combine these materials in a layered form and shape the product into pipe, sheet, profile or other desirable shapes that can be sized in a later step. The most common multilayer foam articles are foam core pipe and sheets. These articles are usually extruded using two or three extruders. One extruder is used to make the foam core layer. If there are only two extruders available, the second one is used to make the solid layers on the inside and outside from the same material. If there are three extruders, the material of the dense layer inside and outside could be different. One of skill in the art would be able to recognize different processes to have multiple layers of multiple materials with more than one layers of foam.

For the extruder that processes the foamed material, the polymer is heated inside the extruder in the presence of foaming and optional nucleating agents above its melting point, which should be higher than the decomposition temperature of the foaming agent. The generated gas is then absorbed by the molten polymer under high pressure. Gases are excellent plasticizers for polymers. For the crystalline and semi-crystalline polymers, inclusion of gas would substantially reduce both the melting temperature and the viscosity of the polymer. In the alternative, a gas is injected into the extruder instead of using a chemical blowing agent. The resulting mixture has very low melt strength and low viscosity and is not suitable for foaming. The reason is that low melt strength would prevent the draw down necessary for sizing the product and result in the rupture of the melt before reaching the sizing device. The low viscosity on the other hand would cause stability problems resulting in non-uniform, large and sometimes collapsed cells. The solution to these problems is to cool down the polymer/gas mixture before exiting the die. In this way, the viscosity and melt strength would increase and the foam would be stable with adequate drawability. The balance between generating enough heat in the extruder to melt the polymer, decomposing enough foaming agent and cooling down the generated polymer/gas mixture in a later stage is key to producing good foam. Therefore, extruder, adaptor and die temperature profiles should be selected very carefully. The pressure at the end of the extruder, melt temperature and the die profile are also other important parameters to control. Preferably, the polymer/gas mixture with suitable melt strength and viscosity would exit the die and be exposed to the atmospheric pressure. At this point, the gas dissolved in the polymer would generates gas cells in the polymer. These cells will keep growing until the gas in the polymer is depleted and the polymer is further cooled down, resisting further expansion, resulting in a balance between the gas pressure in the bubble and the extensional viscosity of the polymer melt. The foam is then shaped in a calibrator. A coextruded solid skin on the internal and external surface would provide the dimensional stability of the foam while the rest of the article is being cooled in the calibrator. It has been found that a 15′ long tank with 20° C. water temperature at 10-20 water vacuum would be sufficient for most hollow articles.

Extrusion of the solid material layers is done using processes known in the art. Co-extrusion dies using various technologies could be used with this invention. Spiral dies and feed block type dies are most common for this application although other die technologies such as pancake and combination dies can also be used.

A tandem extrusion process in a single unit operation is also contemplated by the invention. In this process the foam is extruded, cooled and shaped, followed by further extrusion of added solid layer(s).

### Uses:

The coextruded multi-layer foam structure of the invention is useful as an article such as, but not limited to pipe, tube, sheet, profile, film, jacketing. One especially useful structure is a foam-core tube or pipe. The foamed multi-layer structure is self-supporting, and needs no internal or external support.

The coextruded structure may be further processed to form a variety of final articles by means known in the art, including but not limited to the thermoforming of sheets into a variety of parts, and the welding of sheets of pipe into complex articles.

In one embodiment, the multi-layer structure, especially a pipe or tube, could further be wrapped in a protective covering, such as a fiber or metal sheath.

Some of the many structures anticipated by the invention include, for example (PVDF is used generically to stand for PVDF homopolymers or copolymers):
a coextruded PVDF foamed core and a PVDF solid layer of the same composition.
a coextruded pipe having a PVDF foam interior, and solid PVDF layers on either side, in which the foam core is at least twice as thick as both solid layers combined.
a film having a branched PVDF foam and a solid PVDF layer.
a sheet having a PVDF foam and a TPU solid layer.
an article having in order a PVDF foam layer, a maleic anhydride grafted PVDF foam layer, and a thermoplastic polyolefin (TPO) layer.
a PVDF foam/solid/PVDF foam article.
a solid PVDF/PVDF foam/solid (PVDF or non-PVDF)/PVDF foam/solid PVDF structure.
a solid PVDF/high density PVDF foam/lower density PVDF foam/solid PVDF
A pipe with a solid PVDF inner layer and foamed PVDF or branched PVDF outer layer.

### EXAMPLES

### Examples 1-6

In the following examples, a three layer foam core PVDF pipe is manufactured using a five layer, five extruder co-extrusion process. The goal was to make a pipe with external diameter of 32 mm and a pipe thickness of 0.5 mm. The foam core density was changed by changing the amount of the foam masterbatch added to the formulation and also by changing the processing conditions most notably, the extruder and die temperature profile and line speed.

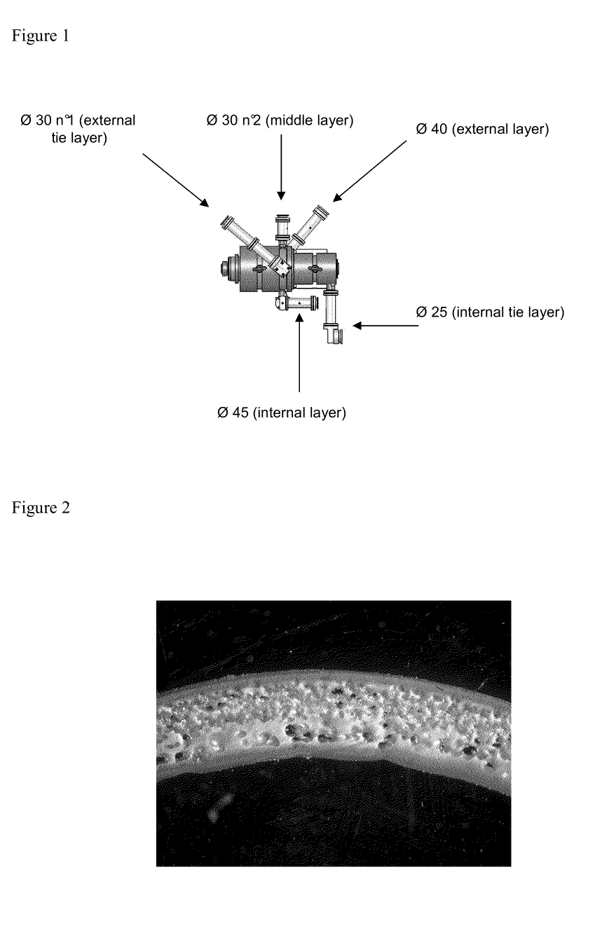

FIG. 1 shows the setup for the five layer die and the size of the extruders connected to it.

A 36 mm (1.417 inches) pin diameter, a 44 mm (1.732 inches) die diameter and a land length of 90 mm (3.543 inches) was used. The draw down ratios were as follows:
DDR1D: 1.6
DDR 2D: 2.17
Draw Balance: 1.03

The internal and external dense layers were KYNAR RX 810 HPC, a copolymer of HFP and PVDF, Tm=143° C. from Arkema Inc., and KYNAR K760 (a high molecular weight PVDF homopolymer)+KYNAR FLEX 2620 FC PLT foam concentrate (a PVDF/HFP copolymer with a chemical blowing agent) for the middle layer.

Since a five layer, five extruder line was used for production of a three layer structure, the most outer (40 mm) and the most inner (45 mm) extruders were used to extrude the same dense material. The three middle extruder (No. 1 30 mm, No. 2 30 mm and 25 mm) were used for the foamed material.

TABLE 1
Table 1 shows the composition of the six samples we are using as examples here.

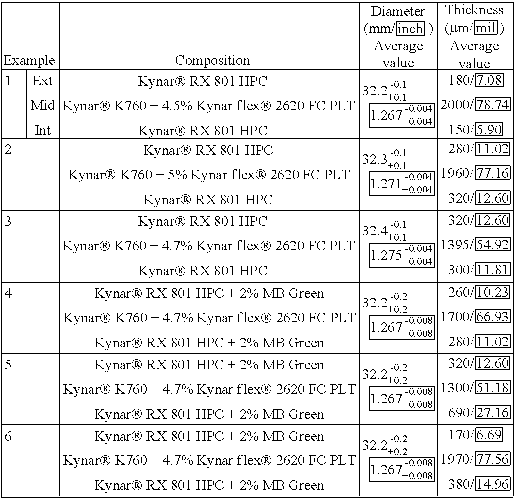

Table shows the processing conditions for Example 2, which are typical of the conditions for all of the other samples.

TABLE 2

| | Position | [symbol] | [symbol] | Zone 1 | Zone 2 | Zone 3 | Zone 4 | Zone 5 | Bride | [symbol] 1 |
|---|---|---|---|---|---|---|---|---|---|---|
| | Position | material | hopper | screw area 1 | screw area 2 | screw area 3 | screw area 4 | screw area 5 | Connection | Tool 1 |
| [symbol] 40 | Ext | Kynar | 20 | 150 | 185 | 195 | 205 | 215 | 192 | 187 |
| | | RX801 | | | | | | | | |
| Extrudeuse 30 N [symbol] | | K760 + 5% | 20 | 160 | 190 | 205 | 220 | 0 | 190 | 185 |
| | | KF 2620 | | | | | | | | |
| | | fc plt | | | | | | | | |
| Extrudeuse 30 N [symbol] | Middle | K760 + 5% | 20 | 160 | 190 | 205 | 220 | 0 | 190 | 190 |
| | | KF 2620 | | | | | | | | |
| | | fc plt | | | | | | | | |
| Extrudeuse [symbol] | | K760 + 5% | 20 | 160 | 190 | 220 | 0 | 0 | 210 | 190 |
| | | KF 2620 | | | | | | | | |
| | | fc plt | | | | | | | | |
| Extrudeuse 45 | Int | Kynar | 20 | 150 | 185 | 190 | 205 | 215 | 192 | 187 |
| | | RX801 | | | | | | | | |

| | [symbol] 2 | [symbol] 3 | [symbol] 4 | [symbol] 5 | [symbol] 6 | [symbol] |
|---|---|---|---|---|---|---|
| | Tool 2 | Tool 3 | Tool 4 | Tool 5 | Tool 6 | Die |
| Extrudeuse 40 | 182 | 182 | 0 | 0 | 0 | 0 |
| Extrudeuse 40 N^{o}1 | 185 | 0 | 0 | 0 | 0 | 0 |
| Extrudeuse 30 N^{o}2 | 0 | 0 | 0 | 0 | 0 | 0 |
| Extrudeuse 25 | 185 | 185 | 0 | 0 | 0 | 0 |
| Extrudeuse 40 | 185 | 192 | 192 | 192 | 190 | 190 |

| | consigne de | | | |
|---|---|---|---|---|
| | vitesse | | | Température |
| | ( [symbol] /min) | Pression | Couple (% | [symbol] (° C.) |
| | Screw speed | (Bar) | max) | Melt |
| | (rpm) | Pressure | Amps | temperature |
| Extrudeuse 40 | 8.5 | 45.4 | 16.7 | 192.8 |
| Extrudeuse 30 N^{o}1 | 24.0 | 385.6 | 20.8 | 192.1 |
| Extrudeuse 30 N^{o}2 | 30.0 | 372.2 | 18.1 | 202.8 |
| Extrudeuse 25 | 81.0 | 298.1 | 20.8 | 222.4 |
| Extrudeuse 40 | 6.0 | 90.7 | 7.4 | 201.5 |

| | |
|---|---|
| Commentaines | structure tricouches kynar expansé a 5% |
| Comments | vitesse de ligne: 1.6 m/min |
| | 0 |

[symbol]

indicates data missing or illegible when filed

FIG. 2 is a magnified cross section of Example 2 which distinctly shows the two dense layers on the outside and inside and the foamed internal layer.

Table 3, thickness of the layers, the overall density reduction and the density reduction just for the core section of the pipe is reported. Moreover, the burst pressures of the pipes using ASTM D1599 are also reported in this table. All of the pipes have burst pressures over 250 Psi. This means that although the density in some cases is reduced by almost 40%, the pipes are still capable of handling high pressures.

TABLE 3

| | | | Total | | | | | | Foam |
|---|---|---|---|---|---|---|---|---|---|
| | Average | | Density | Wall | OD | Core | ID | Foam | Density |
| | Burst | Density | Reduction | Thickness | Layer | Layer | Layer | Density | Reduction |
| Example | (psi) | (g/cc) | (%) | (in) | (in) | (in) | (in) | (g/cc) | (%) |
| Control | 1593 | 1.7900 | 0 | 0.126 | Dense Kynar | | | 1.7900 | 0% |
| Pipe | | | | | | | | | |
| (Soild) | | | | | | | | | |
| 1 | 526 | 1.4320 | 20 | 0.094 | 0.033 | 0.049 | 0.012 | 1.4320 | 38% |
| 2 | 460 | 1.3067 | 27 | 0.087 | 0.014 | 0.058 | 0.015 | 1.3067 | 41% |
| 3 | 433 | 1.3246 | 26 | 0.090 | 0.003 | 0.072 | 0.014 | 1.3246 | 32% |
| 4 | 333 | 1.2530 | 30 | 0.099 | 0.021 | 0.078 | 0.000 | 1.2530 | 38% |
| 5 | 333 | 1.1456 | 36 | 0.110 | 0.018 | 0.073 | 0.019 | 1.1456 | 54% |
| 6 | 286 | 1.0919 | 39 | 0.103 | 0.016 | 0.072 | 0.015 | 1.0919 | 56% |

### Example 7

A three layer foam core PVDF sheet is manufactured using a three layer, three extruder co-extrusion process. The goal was to make a sheet with dense external layers and a foamed core. A line with three one inch single screw extruders and a three layer co-extrusion feed Hock system was used. The sheet die was 12″ and had an opening of ¼″. A three roll stack was used to size and cool the foam core sheet. KYNAR 2.500 (high molecular weight PVDF/HFP, Tm=122° C.) copolymer was used for the dense skin and a mixture of KYNAR 2800 (PVDF/HFP copolymer Tm=143° C.)+4% KYNAR 2620 FC PLT foam concentrate was used for the foam core layer. Following extrusion conditions were used for the foam core layer.

TABLE 4

| Bar- | Bar- | Bar- | Bar- | | | | Head | Melt | Water |
|---|---|---|---|---|---|---|---|---|---|
| rel 1 | rel 2 | rel 3 | rel 4 | Die 1 | Die 2 | Die 3 | Press. | Temp | Temp |
| (° F.) | (° F.) | (° F.) | (° F.) | (° F.) | (° F.) | (° F.) | (psi) | (° F.) | (° F.) |
| 390 | 390 | 430 | 450 | 340 | 340 | 340 | 580 | 385 | 52 |

Following temperature profile was used for extrusion of the dense skins.

TABLE 5

| Barrel 1 (° F.) | Barrel 2 (° F.) | Barrel 3 (° F.) | Barrel 4 (° F.) |
|---|---|---|---|
| 390 | 390 | 430 | 430 |

The roll temperature for the finishing section was 120° F. The experiment resulted in a three layer foam core sheet with the overall thickness of 0.16″. The top and bottom layer thickness were 0.024″ and 0.020″, respectively. This means that almost 30% of the thickness is coming from the dense material and 70% from the foam material. The foam core density was 1.21 g/cc which is a 32.2% density reduction and the overall density reduction was 28.6%. The surface finish and quality of the sheet was very good and distinct layers could be observed.

What is claimed is:

1. A multi-layer structure comprising at least two layers that are coextruded, comprising:
a) at least one layer comprising a foamed crystalline or semi-crystalline fluoropolymer having a density of at least 3 percent less than an unfoamed semi-crystalline fluoropolymer of the same composition, wherein said foamed semi-crystalline fluoropolymer is coextruded as a foam, and
b) a thermoplastic polymer layer.

2. The multi-layer structure of claim 1, wherein said foamed fluoropolymer layer comprises a polyvinylidene fluororide homopolymer or copolymer.

3. The multi-layer structure of claim 2, wherein said foamed fluoropolymer is a copolymer having 71-99 weight percent of vinylidene fluoride units and 1 to 29 weight percent of hexafluoropropene units.

4. The multi-layer structure of claim 1, wherein said foam is not cross-linked.

5. The multi-layer structure of claim 1, wherein said structure consists of, in order, a solid layer, a foam layer, and a solid layer, wherein said layers are directly attached to each other at the interface.

6. The multi-layer structure of claim 1, wherein all layers comprise fluoropolymers.

7. The multi-layer structure of claim 1, wherein the difference in the melting point of said fluoropolymer foam layer and said thermoplastic layer is less than 60° C.

8. The multi-layer structure of claim 1, wherein said structure is a pipe, profile, film, sheet, or rod.

9. The multi-layer structure of claim 1, wherein said fluoropolymer foam layer further comprises residual nucleating agent selected from the group consisting of calcium carbonate, calcium sulfate, magnesium hydroxide, calcium tungstate, magnesium oxide, lead oxide, barium oxide, titanium dioxide, zinc oxide, antimony oxide, boron nitride, magnesium carbonate, lead carbonate, zinc carbonate, barium carbonate, calcium silicate, aluminosilicate, carbon black, graphite, non organic pigments, alumina, molybdenum disulfide, zinc stearate, PTFE particles, and calcium metasilicate.

10. The multi-layer structure of claim 1, wherein said fluoropolymer foam layer further comprises a chemical blowing agent selected from the group consisting of azodicarbonamide, azodiisobutyronitile, sulfonylsemicarbazide, 4,4-oxybenzene, barium azodicarboxylate, 5-Phenyltetrazole, p-toluenesulfonylsemicarbazide, diisopropyl hydrazodicarboxylate, 4,4′-oxybis(benzenesulfonylhydrazide), diphenylsulfone-3,3′-disulfohydrazide, isatoic anhydride, N,N′-dimethyl-N,N′dinitroterephthalamide, citric acid, sodium bicarbonate, monosodium citrate, anhydrous citric acid, trihydrazinotriazine, N,N′-dinitroso-pentamethylenetetramine, and p-toluenesulfonylhydrazide, and mixtures thereof.

11. The multi-layer structure of claim 1, wherein at least one layer further comprises one or more additives selected from the group consisting of impact modifiers, UV stabilizers, plasticizers, fillers, coloring agents, pigments, dyes, antioxidants, antistatic agents, flame retardants, surfactants, toner, pigments, and dispersing aids.

12. The multi-layer structure of claim 1, wherein said foam layer is from 25 to 50,000 microns thick.

13. The multi-layer structure of claim 1, wherein said other thermoplastic layer is a fluoropolymer.

14. The multi-layer structure of claim 1, wherein said other thermoplastic layer comprises a fluoropolymer foam having a different density.

15. The multi-layer structure of claim 1, wherein said other thermoplastic layer comprises a non-fluoropolymer, selected from the group consisting of thermoplastic polyurethane, thermoplastic polyolefin, and (meth)acrylates.

16. The multi-layer structure of claim 1, wherein said fluoropolymer foam comprises a functionalized polyvinylidene fluoride polymer.

17. A process for the production of a multi-layer foamed fluoropolymer foam structure comprising the steps of
a) coextruding:
1) a fluoropolymer foam—comprising the steps of
(a) blending a fluoropolymer resin, optional blowing agent and optional nucleating agent;
b) processing the fluoropolymer resin, optional blowing agent, and optional nucleating agent and other additives and gas formed either upon the heating of the blowing agent or by injection of a gas, to form a homogeneous mixture;
c) cooling the fluoropolymer/gas mixture in the end of the extruder, adapter and/or die, and
d) extruding the fluoropolymer/gas mixture from the extruder o form a fluoropolymer foam; and
2) at least one other fluoropolymer;
b) cooling the resulting structure; and
c) optionally cutting the resulting cooled structure to a desired size.

18. The process of claim 17, wherein said blowing agent, optional nucleating agent and optionally other additives are added as a masterbatch.

19. The process of claim 18, wherein said master batch (a) comprises from 0.5 to 20% nucleating agent and optionally from 1 to 20 weight percent blowing agent, based on the weight of polymer solids.
